(19) United States
(12) Patent Application Publication
(10) Pub. No.: US 2015/0168977 A1
(43) Pub. Date: Jun. 18, 2015

(54) ENERGY ANALYSIS SYSTEM AND METHODS OF OPERATING THE SAME

(71) Applicant: Environmental Systems, Inc.

(72) Inventors: Paul Oswald, Brookfield, WI (US); Brian Oswald, Colgate, WI (US); Christopher Fawley, Oconomowoc, WI (US); Benjamin Pernitzke, Oconomowoc, WI (US); Joseph Grey, Franklin, WI (US); Steven Krytkowski, Greenfield, WI (US); Nicholas Harker, Pewaukee, WI (US); Brendon Dorn, Milwaukee, WI (US); Jacquelyn Schultz, West Bend, WI (US); Darryl Benson, Crystal Lake, IL (US)

(21) Appl. No.: 14/567,734

(22) Filed: Dec. 11, 2014

Related U.S. Application Data
(60) Provisional application No. 61/915,640, filed on Dec. 13, 2013.

(51) Int. Cl. G05F 1/66; G05B 15/02

(52) U.S. Cl. CPC G05F 1/66; G05B 15/02

(57) ABSTRACT

An energy management system including a memory, a processor, and an information gathering unit with a program in the processor performing the steps of gathering operational characteristics for at least two operating devices via the information gathering unit, determining operational relationships between each operating devices and the operational characteristics of each operating device, calculating a deviation between at least operational characteristic of each operational device and an expected value of the characteristic, determining the cost associated with the deviation, and displaying the cost to a user via a display on a user device.

### RELATED APPLICATIONS

This application is a non-provisional application that claims the benefit of an the priority from U.S. Provisional Application No. 61/915,640 filed Dec. 13, 2013, titled “ENERGY ANALYSIS SYSTEM AND METHODS OF OPERATING THE SAME”

### BACKGROUND OF THE INVENTION

As energy costs increase, the need to reduce the cost of operating different systems in a facility also increases. Facilities spend millions of dollars every year installing energy efficient systems to control lighting, heating ventilation and air conditioning, security, and other building systems. The efficiency of these systems is directly related to how the systems are controlled and operated. A minor error in the operation of the system can compound into wasted energy. Further, due to the interaction of multiple systems, an error in a single system can affect may different systems in a facility.

As the need for better energy efficiency increases, the need to properly analyze the operation of these systems becomes increasingly important. Further, the need to quantify the monetary loss resulting from the incorrect operation of these system also increases.

### SUMMARY OF THE INVENTION

One embodiment of the present invention includes an energy management system including a memory, a processor, and an information gathering unit with a program in the processor performing the steps of gathering operational characteristics for at least two operating devices via the information gathering unit, determining operational relationships between each operating device and the operational characteristics of each operating device, calculating a deviation between at least one operational characteristic of each operating device and an expected value of the characteristic, determining the cost associated with the deviation, displaying the cost to a user via a display on a user device.

In another embodiment, the program performs the steps of establishing a communication connection to at least one control system via a network.

In another embodiment, the program performs the step of requesting information on operating devices controlled or monitored by the control system.

In another embodiment, the program performs the step of determining physical relationships between each of the operating devices.

In another embodiment, the expected value varying over a predetermined time.

In another embodiment, the program performs the step of determining the cost associated with a deviation includes the step of determining the duration of the deviation.

In another embodiment, the program performs the step of determining the cost associated with a deviation includes the step of applying a weighing value to each deviation.

In another embodiment, the weighing value being based on an equipment type, climate zone or deviation history.

In another embodiment, the program performs the step of determining the cost associated with a deviation includes the step of determining the operational effect of the deviation on related devices based on the operational relationships between devices.

Another embodiment of the present invention includes an equipment testing system including a memory, a processor, and an information gathering unit with a program in the processor performing the steps of identifying a device associated with an operational deviation, establishing a communication connection with a device controlling the operation of the device, retrieving a test routine that includes a plurality of commands each with an expected reaction by the device, the test routine being based on a category of the device and a category of the deviation sending a first command to the device, receiving a response from the device, determining if the response corresponds to the expected reaction by the device, ending a second command based on the reaction to the first command.

In another embodiment, more than one command is associated with an expected reaction of the device.

In another embodiment, the expected reaction is measured by a sensor connected to the device.

In another embodiment, the program performs the step of generating a report detailing the results of the test.

In another embodiment, the program performs the step of determining the cause of an unexpected result.

In another embodiment, the program performs the step of generating a work order to correct the cause of the unexpected result.

In another embodiment, the program performs the step of initiating second test based on the work order.

In another embodiment, the communication connection is a BACnet connection.

In another embodiment, the communication connection is a LonWorks connection.

In another embodiment, the communication connection is a Modbus connection.

In another embodiment, the communication connection includes a plurality of communication connections.

### BRIEF DESCRIPTION OF THE DRAWING

Details of the present invention, including non-limiting benefits and advantages, will become more readily apparent to those of ordinary skill in the relevant art after reviewing the following detailed description and accompanying drawings, wherein:

FIG. 1 depicts a block diagram of an energy analysis unit suitable for use with the methods and systems consistent with the present invention;

FIG. 2 shows a more detailed depiction of the energy analysis unit of FIG. 1;

FIG. 3 shows a more detailed depiction of the computers of FIG. 1;

FIG. 4A depicts an illustrative example of the operation of the energy analysis system;

FIG. 4B illustrates one embodiment of information stored in the information storage unit;

FIG. 5 depicts an illustration of the operation of the energy analysis system 100 connecting to a building system and retrieving information;

FIG. 6 depicts an illustration of the operation of the condition analysis unit in analyzing the information stored in the information storage unit;

FIG. 7 depicts an illustrative example of the correlation analysis unit analyzing the listing of stored deviations;

FIG. 8 depicts an illustrative example of the correlation analysis unit applying a rule to a deviation and determining the corresponding energy usage of each group of deviations;

FIG. 9 depicts an illustrative example of the correlation analysis unit determining the increased energy consumption resulting from a deviation;

FIG. 10 is a graphical representation of the Space.T values over a deviation period; and

FIG. 11 depicts an illustrative example of the information gathering unit connecting to a control system controlling a system associated with a deviation to troubleshoot the system.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

Described herein is a system for gathering and analyzing the operational efficiency of a building. The system connects to building systems in a building and analyzes the information against known values to determine whether the systems in the building are operating properly. If a building system is operating inefficiently, or improperly, the system automatically determines the monetary cost resulting from the incorrect operation of the system. The system also determines residual costs resulting from the improper operation of the system by examining information correlated to the system, being analyzed.

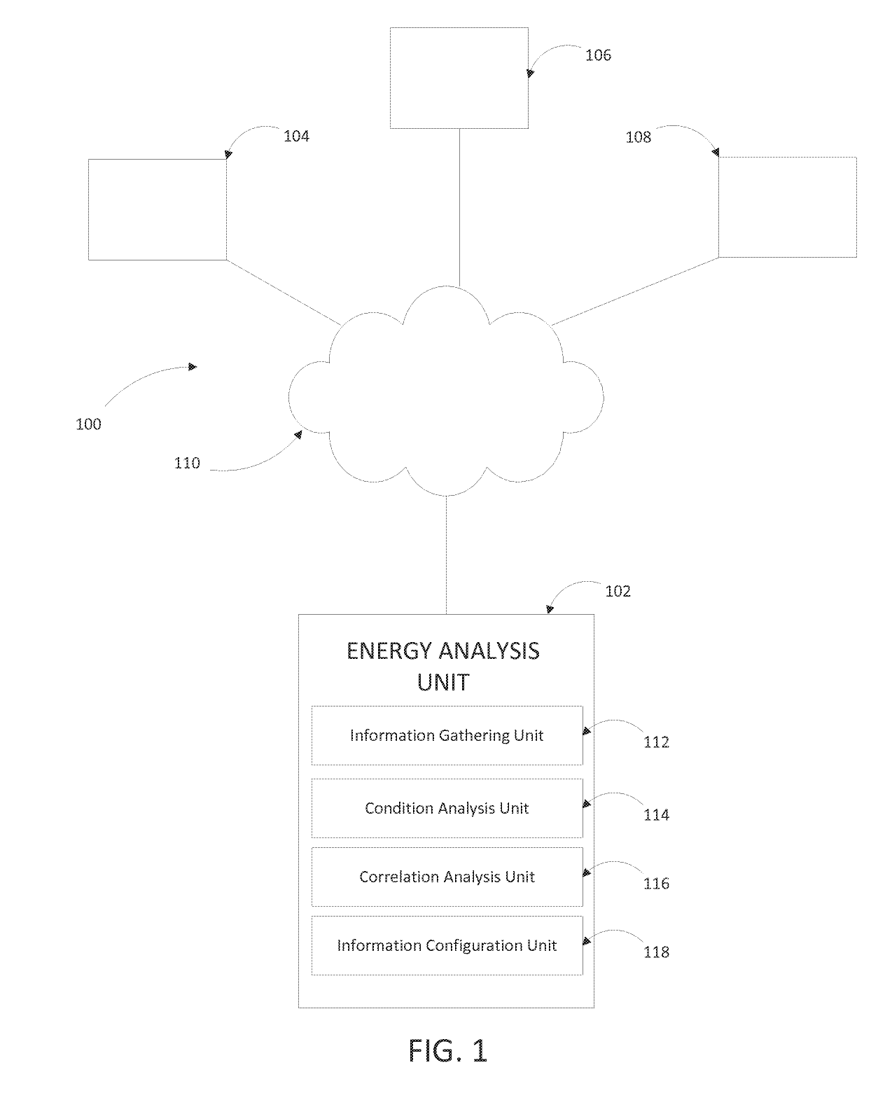

FIG. 1 depicts a block diagram of an energy analysis unit 100 suitable for use with the methods and systems consistent with the present invention. The energy analysis unit 100 comprises a plurality of computers 102, 104, 106 and 108 connected via a network 110. The network 108 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104 and 106 shown in FIG. 1 is connected to the network 110 via a suitable communication link, such as a dedicated communication line or a wireless communication link.

In an illustrative example, computer 102 serves as an energy analysis unit that includes an information gathering unit 112, a condition analysis unit 114, a correlation analysis unit 116 and an information configuration unit 118. The number of computers and the network configuration shown in FIG. 1 are merely an illustrative example. One having skill in the art will appreciate that the energy analysis system 100 may include a different number of computers and networks. For example, computer 102 may include the information gathering unit 112 as well as one or more of the conditional analysis unit 114 and information configuration unit 118. Further, the correlation analysis unit 116 may reside on a different computer than computer 102.

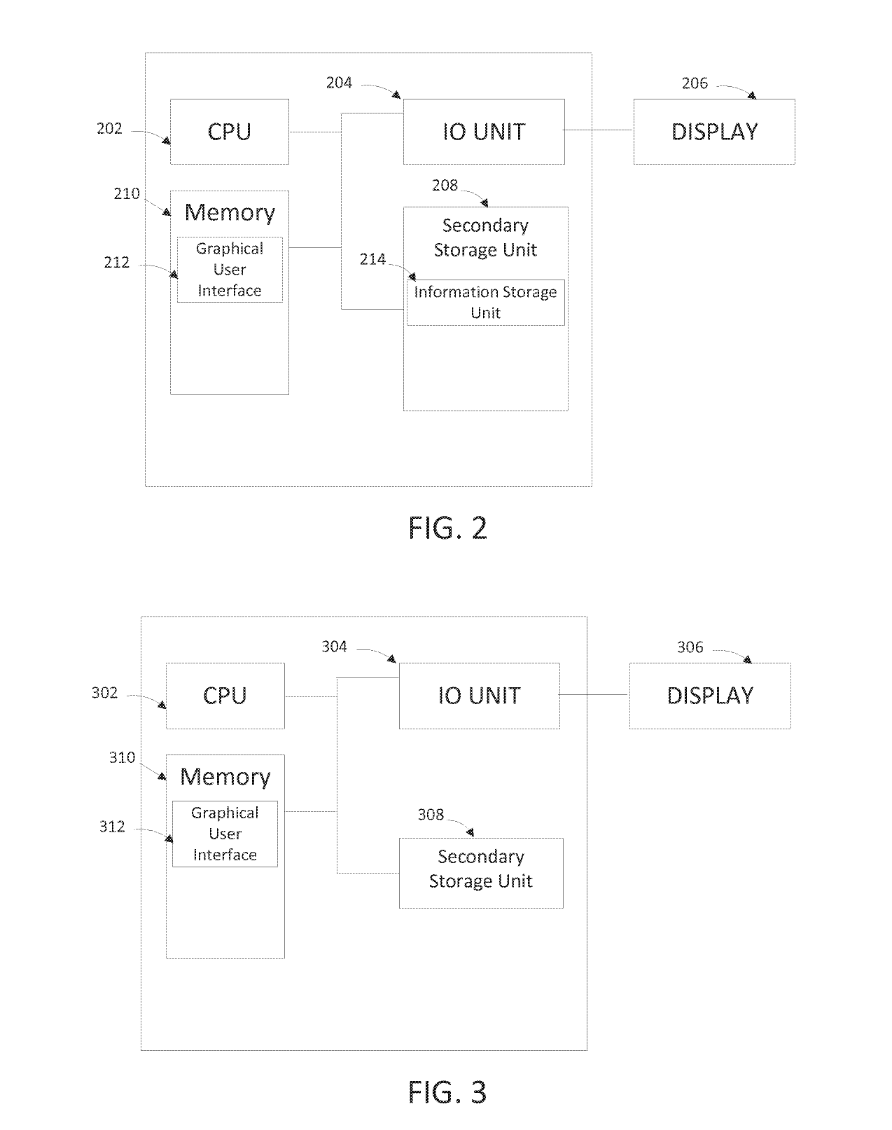

FIG. 2 shows a more detailed depiction of the computer 102. The computer 102 comprises a central processing unit (CPU) 202, an input output (10) unit 204, a display device 206 communicatively coupled to the IO Unit 204, a secondary storage device 208, and a memory 210. The computer 202 may further comprise standard input devices such as a keyboard, a mouse, a digitizer, or a speech processing means (each not illustrated).

The computer 102's memory 210 includes a Graphical User Interface (“GUI”) 212 which is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer, Google Chrome or any other commercially available HTML viewing software. The secondary storage unit 208 may include an information storage unit 214. The information storage unit may be a rational database such as, but not including Microsoft's SQL, Oracle or any other database.

FIG. 3 shows a more detailed depiction of the computers 104, 106 and 108. Each computer 104, 106 and 108 comprises a central processing unit (CPU) 302, an input output (I/O) unit 304, a display device 306 communicatively coupled to the IO Unit 304, a secondary storage device 308, and a memory 310. Each computer 104, 106 and 108 may further comprise standard input devices such as a keyboard, a mouse, a digitizer, or a speech processing means (each not illustrated).

Each computer 104, 106 and 108's memory 310 includes a Graphical User Interface (“GUI”) 312 which is used to gather information from a user via the display device 306 and I/O unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present invention, the GUI 312 is displayed using commercially available hypertext markup language (“HTML”) viewing software such as, but not limited to, Microsoft Internet Explorer, Google Chrome or any other commercially available HTML viewing software.

At least one of computer 104, 106 and 108 may be a programmable logic controller (PLC) that is used to monitor and control equipment in a buildings. Inputs, such as sensors, and outputs, such as relays and variable voltage and current signals, are electrically coupled to the IO unit 304. Operational instructions are stored in the memory 310 of the PLC that adjust outputs in response to the signal transmitted from one or more input sensors. In one embodiment, the at least one computer 104, 106 and 108 is a master PLCs that is communicatively coupled to a plurality of slave PLC communicating over a second network.

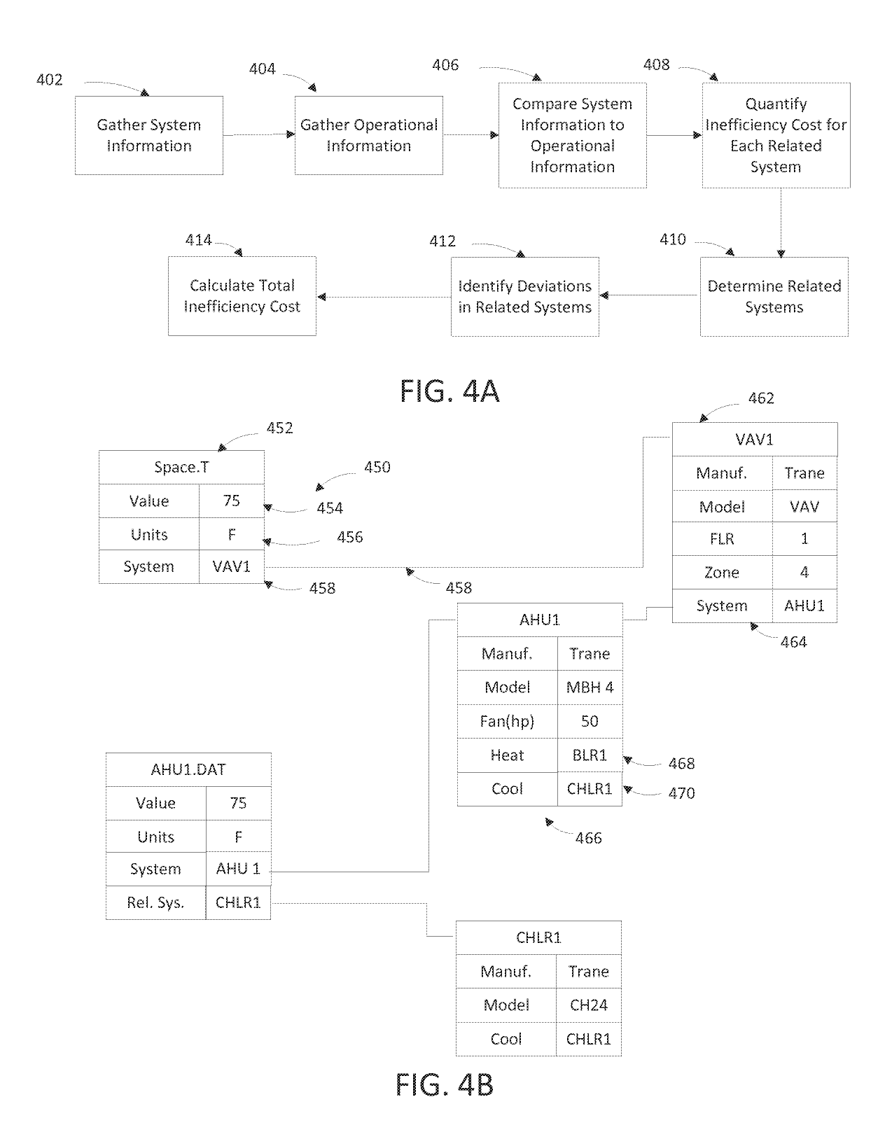

FIG. 4A depicts an illustrative example of the operation of the energy analysis system 100. In step 402, the information gathering unit 112 in the energy analysis unit 102 connects to at least one of the computers 104, 106 or 108. Each computer 104, 106 or 108 may be operating software that is configured to gather information on conditions in a building. As an illustrative example, computer 104 may be operating software to gather information on environmental conditions in a building such as the temperature, pressure status of different components in the building's heating, ventilating and air conditioning (“HVAC”) systems, information on building security, or any other building information. Computer 106 may be operating point of sale software configured to report sales volume of different registers positioned throughout a retail store.

In step 404, the information gathering unit 112 retrieves information from each of the connected systems. The information gathering unit 112 may retrieve all available information, or a predetermined amount of information, from each connected system. The retrieved information is stored in the information storage unit 214. The information storage unit 214 may a database such as Microsoft's SQL, or any other database. In step 406, the gathered information is compared to known or expected values stored in the information storage unit 214 by the condition analysis unit 114. As an illustrative example, the information gathering unit 112 may retrieve a space temperature associated with a specific time period and day. An expected value of the space temperature may be stored in the information storage unit 214, and the condition analysis unit 114 may compare the retrieved value to the expected value. If the retrieved value deviates from the expected value by more than a predetermined amount, the condition analysis unit 114 identifies the deviation and analyzes additional information concerning the mechanical systems controlling the space associated with the space temperature reading.

The condition analysis unit 114 may perform a second level of analysis where each operational condition of the mechanical system associated with the space temperature is compared to a second set of expected values. The condition analysis unit 114 may determine the different mechanical systems that are operating incorrectly, along with the amount of deviation of each component. In step 408, the condition analysis unit 114 calculates a monetary cost for the deviation. The information storage unit 214 may include a table storing a cost per unit of energy used during a deviation. As an illustrative example, the cost of using an extra kilowatt hour may be stored as 0.08 cents per kilowatt hour. The condition analysis unit 114 determines the amount of excess energy used by a system over a specified period of time. As an illustrative example, the condition analysis unit 114 may determine that a fan in an HVAC system operated for one hour longer than expected. The system may calculate the amount of electrical power used to operate the fan for one hour using operational information, such as the fan horse power, on the fan that is stored in the information storage unit 214.

In step 410, the correlation analysis unit 116 identifies other systems that are related to the analyzed system. The information storage unit 214 may include a table listing relationships between different systems. As an illustrative example, a chiller may be related to a specific air handling unit (AHU). The relationships are used to determine the total cost of a operational deviation. In step 412, the correlation analysis unit 116 identifies deviations in the related systems and calculates the cost of the deviation. In step 414, the total inefficiency cost resulting from the inefficient operation of the mechanical device is determined.

FIG. 4B illustrates one embodiment of information stored in the information storage unit 214. The information storage unit 214 includes a plurality of objects representing information gathered from a building system. The objects are categorized based on the type of information stored in each object, the type of device associated with the object, the category of the device associated with the object, and any other information associated with an object. Each object also includes a plurality of attributes that include information on the type of information stored in the object. As an illustrative example, a temperature sensing object 450 may store information on a space temperature sensor located in a space in the building and an AHU may store information such as fan size, air flow specification, cooling load, or any other information pertaining to the physical AHU. The object 450 may include an object identifier 452 indicating the name of the sensor, a value attribute 454 indicating the value of the object at a given time, a units of measure attribute 456 indicating the units of measure for the value attribute, and a related system attribute 458. The related system attribute 458 indicates the system in the building that are logically related to the object. For example, the object Space.T 452 is controlled by a variable air volume (“VAV”) unit VAV1, and it therefore related to the VAV1 object.

The system attribute 458 is logically linked to an object representing the related system. For example, the system attribute VAV1 is logically related to the object VAV1 by relationship line 460. The object VAV1 includes attributes used to describe a VAV unit such as, the model, manufacturer and location attributes. The location attributes may be identified as a floor or a zone of a building, or as a Global Positioning Satellite (“GPS”) coordinate. The VAV1 object 460 includes a system attribute 464 logically relating the VAV1 object to an AHU1 object 466. The AHU1 object 466 also includes multiple system relationships including a heating system relationship 468 and a cooling system relationship 470. The AHU1 object 466 includes components associated with an AHU such as the horsepower of a supply fan 470 in AHU1 466. AHU1 may include links to other components such as heating valves, cooling valves dampers, and other components physically included in AHU1.

The information storage unit 214 stores each object along with the relationships associated with each object. The information storage unit 214 may be any relational database including, but not limited to, Microsoft SQL, Oracle, DBGeO or any other relational or multi-dimensional database. By storing the information in a database, detailed energy efficiency determinations can be calculated. For example, an increase in space temperature due to lighting being left on can be calculated across multiple systems in a facility.

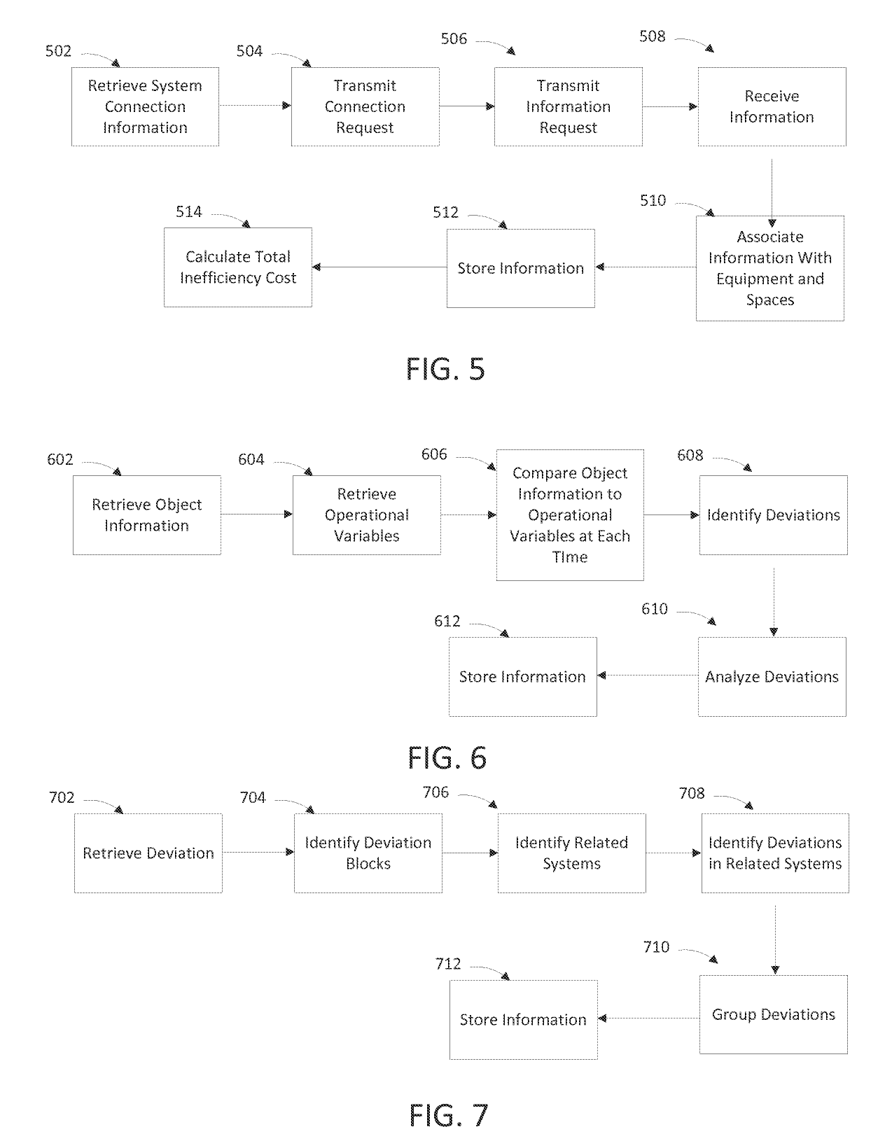

FIG. 5 depicts an illustration of the operation of the energy analysis system 100 connecting to a building system and retrieving information. In step 502, the information gathering unit 112 retrieves connection information from the information storage unit 214. The connection information may include the network address of the building system, communication information used to connect to the building system, the communication protocol used by the building system, and any other information required to establish a communication connection with the building system. In step 504, the information gathering unit 112 transmits a connection request to the building system. The connection request is configured based on the communication protocol used by the building system As an illustrative example, the communication protocol for a building automation system may be BacNet, LonWorks, Modbus, or any other communication protocol. In step 506, the information gathering unit 112 transmits an information request to the building system. The information request includes requests for information on the objects stored in the information storage unit 214 that are related to the building system. In step 508, the building system responds to the request for information by transmitting the information on the requested objects in a predetermined format. In step 510, the information gathering unit 112, analyzes each requested object and stores the information on each object in the information storage unit 214. The information may be transmitted as a series of entries in a log which is stored in a table in the information storage unit 214 and associated with the corresponding objects and devices in the information storage unit 214.

FIG. 6 depicts an illustration of the operation of the condition analysis unit 114 in analyzing the information stored in the information storage unit 214. In step 602, the condition analysis unit 602 retrieves information on a first object. The information may be stored in a log format in the information storage unit 214 such that one or more of the attributes of each object are associated with a date and time. Further, the system may restrict its analysis of object information to sensing objects, such as temperature and pressure sensors. In step 604, the conditional analysis unit 114 retrieves the operation variables for each object. The operational variables represent desired values for the attributes of each object at a given time and date. The operational variables may be entered directly into the information storage unit 214 or may be gathered by the information gathering unit 112 from each system.

In step 606, the condition analysis unit 114 compares the attributes of each object to the expected operational variable over each time period. As an illustrative example, the conditional analysis unit 114 may compare the value 454 of the Space.T object 452 to a corresponding desired set point over a specified time frame. In step 608, the condition analysis unit 114 identifies dates and times when an attribute of an object deviated from the desired setpoint by a predetermined value. The predetermined value may be entered into the information storage unit 214 by a user via a GUI, or may be retrieved by the information gathering unit 112 from the system or from a remote location such as a second server connected to the network 110.

In step 610, the condition analysis unit 114 analyzes each deviation to determine if the deviation is larger than a predetermined deviation value. The predetermined deviation value may be entered into the information storage unit 214 by a user via a GUI, or may be retrieved by the information gathering unit 112 from the system or from a remote location such as a second server connected to the network 110. The predetermined deviation value may be a constant value or may vary over time. In step 612, each entry having a deviation greater than or equal to the predetermined deviation value is stored in the information storage unit 214. Each deviation may be stored in a separate table or may be identified as a deviation in the object stored in the information storage unit 214.

FIG. 7 depicts an illustrative example of the correlation analysis unit 116 analyzing the listing of stored deviations. In step 702, the correlation analysis unit 116 retrieves a listing of deviations for a first object. In step 704, the correlation analysis unit 116 determines the total duration of each deviation by analyzing the length of time each deviation occurred. As an illustrative example, if a space temperature was two degrees above its setpoint for fifteen minutes and then rose to five degrees above setpoint for three hours, the correlation analysis unit 116 would create two separate deviation entries for each deviation base do on the amount of deviation and the duration of the deviation.

In step 706, the correlation analysis unit 116 identifies other objects related to the first object. As an illustrative example, the correlation analysis unit 116 identifies VAV1 as being related to the Space.T object 452, as well as, the AHU1 466, CHLR1 and BLR 1 objects and their associated objects. In step 708, the correlation analysis unit 116 identifies deviations in each of the related units using the same methods used in step 704. In step 710, the correlation analysis unit 116 groups the identified deviations from each related system by date, time and deviation value. In step 712, the correlation analysis unit 116 stores the grouped deviations in the information storage unit 214.

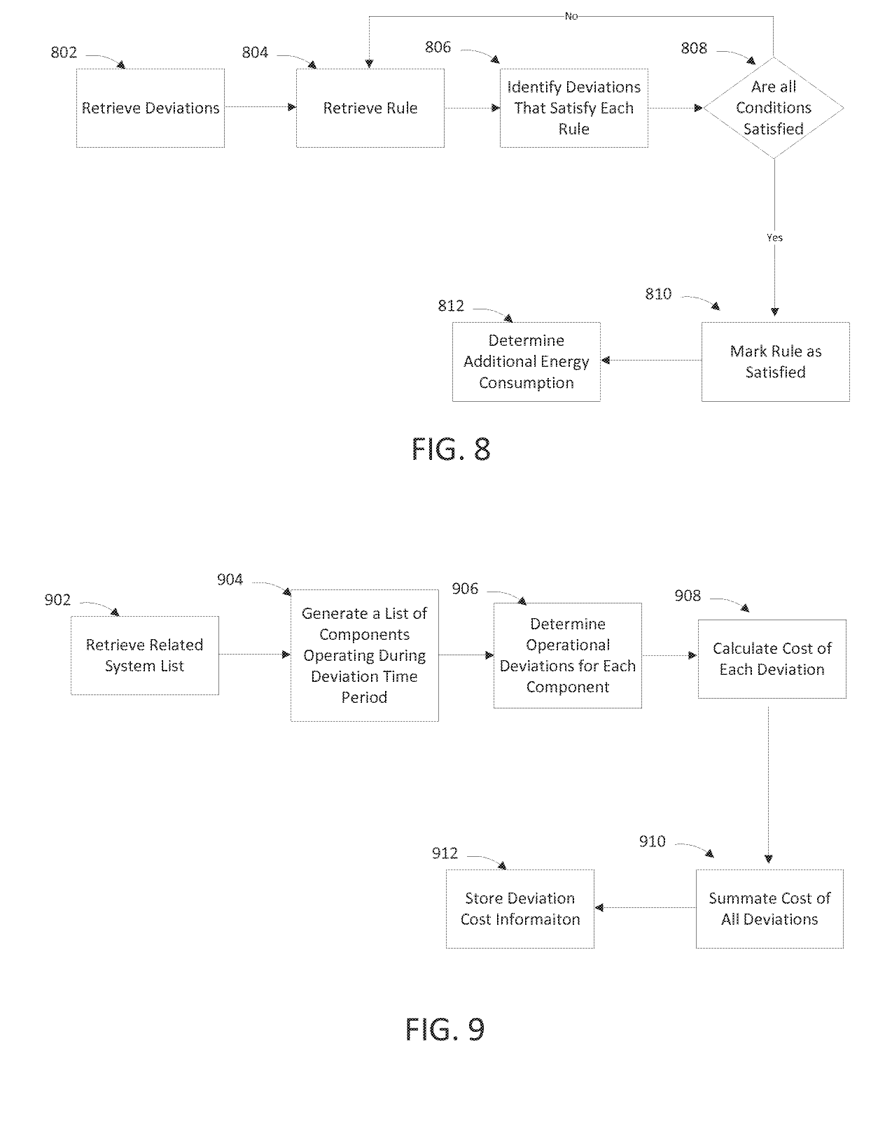

FIG. 8 depicts an illustrative example of the correlation analysis unit 116 applying a rule to a deviation and determining the corresponding energy usage of each group of deviations. In step 802, the correlation analysis unit 116 retrieves a first group of deviations from the grouped deviations in the information storage unit 214. In step 804, the correlation analysis unit 116 retrieves a listing of rules from the rules table based on the object types included in the retrieved deviations. In step 806, the correlation analysis unit 116 applies each rule to each deviation. To apply a rule, the correlation analysis unit 116 inserts the values associated with each deviation into the rule to determine whether each element of the rule is satisfied. The correlation analysis unit 116 may apply a weighting value to the deviation based climate zone, equipment, equipment age, utilization of the space connected to the equipment, default history or any other metric that can used to weight deviation values. As an illustrative example, if a rule requires the AHU1 466 supply fan to operate while the Space.T 452 temperature is above 75 degrees, the correlation analysis unit 116 would examine each deviation to determine when the conditions of the AHU1 466 supply fan operating and the Space.T value 454 above 75 degrees occurred. In step 808, if all conditions of a rule are satisfied, the rule is marked as satisfied in step 810 and each deviation stored in the information storage unit is associated with the rule. In step 812, the correlation analysis unit 116 determines the additional energy consumption occurring for each satisfied rule. To determine the energy consumption, the correlation analysis unit 116 converts the consumption parameters of each related system that was required to operate longer or to operate at a higher consumption rate.

FIG. 9 depicts an illustrative example of the correlation analysis unit 116 determining the increased energy consumption resulting from a deviation. In step 902, the correlation analysis unit 116 retrieves a listing of all systems related, both directly and indirectly, to the object generating the deviation. In step 904, the correlation analysis unit 114 generates a listing of components for each system by querying the information storage unit 214. A component is defined as a physical device controlled by the system. As an illustrative example, an AHU may include a fan component, a cooling valve component, a damper component, and a heating valve component each of which is a mechanical, or electro mechanical device, coupled to the AHU. In step 906, the correlation analysis unit 116 determines if a deviation in operation occurred for each component (component deviation), during the object deviation period. A component deviation occurs when a component operates in a manner different than the expected manner. As an illustrative example, if the Space.T 452 object incurs a deviation where the Space.T value 454 is greater than 75 degrees, a cooling valve on AHU1 466 may open to attempt to cool the Space.T value 454 to its desired setpoint. The opening of the valve would represent a deviation, because the valve would open more to bring then Space.T value 454 to its desired setpoint then would be required if the Space.T value was less than 75 degrees. The amount of the deviation is calculated as the additional percentage the valve opens to provide additional cooling. As another illustrative example, if the fan in AHU1 466 turns on to provide cool air to the Space.T 452 room, the additional time the fan runs would be a deviation.

In step 908, the correlation analysis unit 116 calculates the cost of each deviation. To calculate the cost, operational characteristics of each component are retrieved from the information storage unit 214. An operation characteristic represents the amount of energy consumed by a component during operation of the component in kilowatt hours. The information storage unit 214 stores a plurality of conversion equations that are related to each component to calculate the amount of energy consumed by each component while operating over a specified period of time. In step 910, the correlation analysis unit 116 summates all of the component deviations caused by the object deviations. In step 912, the summated deviations are stored in the memory 210 of the energy analysis unit 102.

FIG. 10 is a graphical representation of the Space.T values 454 over a deviation period. As FIG. 10 depicts, the Space.T value 454 fluctuates between the setpoint of 75 degrees and a high value of 80 degrees between the hours of 1:00 pm and 2:00 pm. The correlation analysis unit 116 gathers a listing of each of the systems related to the Space.T object 452 including AHU1 466 and CHLR1. The correlation analysis unit 116 then identifies the components related to each system, along with the values for objects representing the operational state of each component. To determine the total cost of the deviation, the correlation analysis unit 114 determines the operational deviations of each of the related systems during the each portion of the deviation time period. In FIG. 10, the deviation periods are determined by analyzing the value attribute as a function of time. As an illustrative example, from 1:20 to 1:30 the Space.T value 454 fluctuated between 77 and 80 degrees. The correlation analysis unit 114 correlates the deviations in Space.T value 454 and the operation of related systems to determine the overall cost of deviation in space temperature.

Returning to FIG. 4B, the correlation control unit 116 reviews the values for the objects representing each component and compares them with expected values for the component based on the time of day, operation mode of the facility, average operational values based on other object values, or any other standardized value. As an illustrative example, the correlation analysis unit 116 may determine that the AHU1 supply fan 470 would not normally be in operation between the deviation period. The correlation analysis unit 116 compares the expected value, the AHU1 supply fan 470 being off, to the value of the object from the building system that represents the actual operation of the fan, such as the value of an airflow sensor. If the object value related to the AHU1 supply fan 470 is ON when the expected value if OFF, the correlation analysis unit 470 records the duration of the AHU1 supply fan 470 as a component deviation.

To calculate the additional energy consumed by the operation of the AHU1 supply fan 470, the correlation analysis unit 116 retrieves an energy equation related to the AHU1 supply fan from the information storage unit 214. The equation may be a conversion factor, such as the conversion of horse power to kilowatt hours. The equation may also be a linear equation incorporating values of more than one object to determine the amount of energy used. For the AHU1 supply fan 470 in FIG. 4B, the equation would be the conversion from horsepower to kilowatt-Hours, (hp×0.735)×number of hours of operation. For the deviation, the amount of energy consumed would equal (50 hp×0.735)×1 hour=36.80 kilowatt-hours, or an increase in usage of 36.80 kilowatt-hours. Applying the cost per kilowatt to the deviation results in a $2.94 deviation cost. The correlation analysis unit 114 performs the same analysis for each component on AHU1, and for all of the systems related to the Space.T object. Further, the correlation analysis unit 114 stores the individual energy consumption of each component and the total energy consumption for each unit in the information storage unit 214.

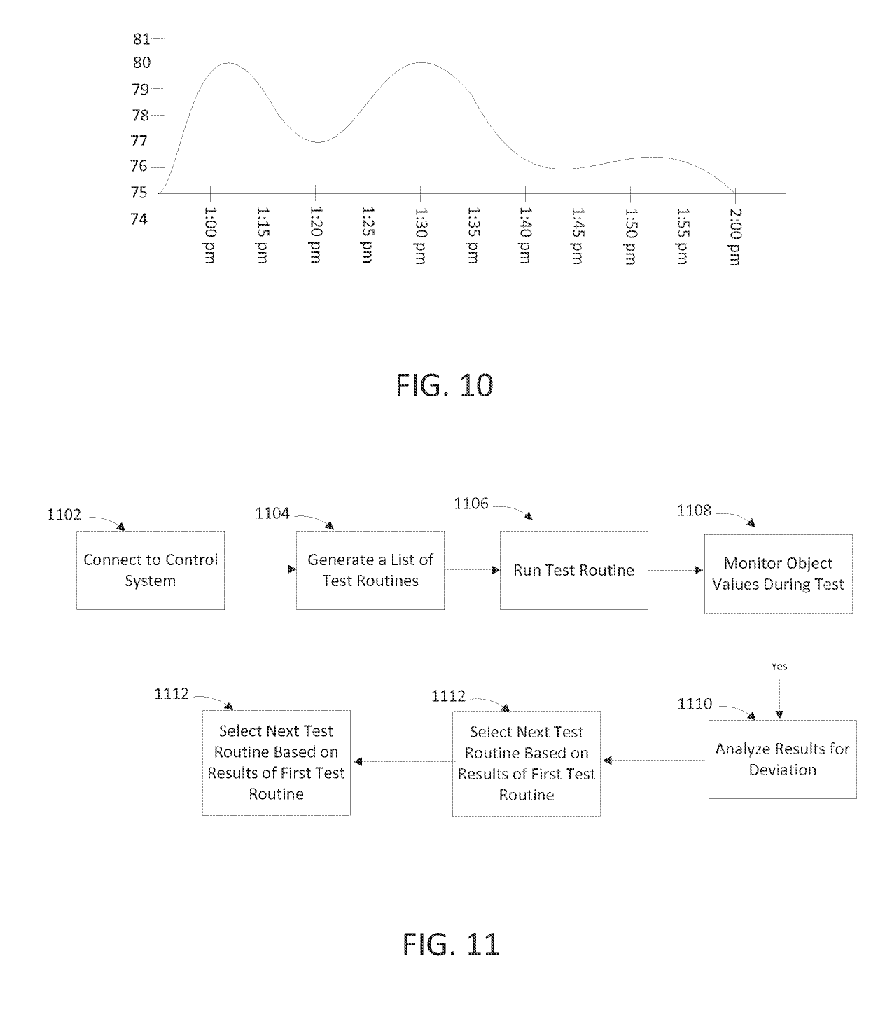

FIG. 11 depicts an illustrative example of the information gathering unit 112 connecting to a control system controlling a building system associated with a deviation to troubleshoot the building system. In step 1102, the information gathering unit 112 connects to the control system via a known communication protocol including, but not limited to, BACnet, LONworks, Modbus or any other known communication protocol. In step 1104, the information gathering unit 112 generates a list of test routines for the system based on the cause of the deviation. The test routines may be stored in the information storage unit 214 and associated with an object or with a term used to describe the cause of a deviation. The test routines may include steps a series of commands to send to a system that allow the information gathering unit to manipulate different components of a system and monitor the result of the manipulations.

In step 1106, the information gathering unit 114 runs the test routine. The information gathering unit 114 may control the components using known commands incorporated into the communication protocol. As an illustrative example, the information gathering unit 114 may transmit a BACnet command to disable a fan output that controls a supply fan on an AHU. The information gathering unit 114 may then turn the fan on and off as part of the test routine. The test routine may include commands to simultaneously control components on the system such as turning the fan on and opening a cooling value. The information gathering unit 112 may run the test routine at a predetermined time or date.

In step 1108, the information gathering unit 112 requests object information from a list of predetermined objects during the operation of each test routine. The object information includes information from sensors monitoring the components on the system being tested. The information gathering unit 112 stores the object information and the corresponding date and time the object information was gathered in the information storage unit 214. In step 1110, after the test is complete, the condition analysis unit 114 analyses the results of the test. In analyzing the test results the condition analysis unit 114 analyzes the requested object information with expected results for the object information based on the control commands sent from the information gathering unit 112. If a value of the object information deviates from the expected value by a predetermined amount, the condition analysis unit 114 identifies the object as having a deviated value. In step 1112, the condition analysis unit 114 selects the next test based on the results of the prior test. If an object value deviated from an expected result in a prior test, the deviation may be used to determine the next routine to test based on a list of routines associated with the object type. As an illustrative example, if the information gathering unit 112 sends a command to turn on a fan, and the object associated with the status of the fan does not report the fan as turning ON, the condition analysis unit 114 may determine the next routine to test using this information.

The condition analysis unit 114 may determine the test routines to operate by applying a series of rules from the information storage unit 214. The rules may require that a series of objects satisfy predetermined conditions before a test routine is selected. The condition analysis unit 114 may apply additional rules to the results of each test routine to determine the next test routine to run on the system.

After the test routines have run, the condition analysis unit 114 may compare the values retrieved during the test to known values to ascertain the cause of the deviation from a known list of causes of deviations. Once the cause of the deviation is determined, the condition analysis unit 114 may transmit a work order request to a work order management system, which generates a work order detailing the work required to correct the cause of the deviation.

In addition to determining energy costs associated with a system failure, the energy analysis system may also determine other, non system related costs, such as lowered sales volume. As an illustrative example, the information gathering unit 112 may retrieve sales information from a point of sale system for the duration of a deviation and the expected sales volume for the time of the duration. The correlation analysis unit 116 may include the potential lost sales that occurred during the deviation.

The system may also apply a fault threshold for a facility, campus or location based on prior deviation information. The fault threshold may be a number of total deviations, a number of specific types a deviation, or any other value associated with a deviation along with the cost per deviation. After a threshold is established the system may monitor the total deviation of the facility, campus or location to determine if the threshold is breached. The system may also monitor the trajectory of the deviations approaching the thresholds. As an illustrative example, the system may calculate a deviation threshold based on a number of prior deviations and the severity of each of the prior deviations. As deviations occur at the location, the system will determine the speed and frequency that the deviations occur to predict when the threshold will be breached.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. An energy management system including a memory, a processor, and an information gathering unit with a program in the processor performing the steps of:
gathering operational characteristics for at least two operating devices via the information gathering unit;
determining operational relationships between each operating device and the operational characteristics of each operating device;
calculating a deviation between at least one operational characteristic of each operating device and an expected value of the characteristic;
determining the cost associated with the deviation;
displaying the cost to a user via a display on a user device.

2. The method of claim 1 including the steps of establishing a communication connection to at least one control system via a network.

3. The method of claim 2 including the step of requesting information on operating devices controlled or monitored by the control system.

4. The method of claim 1 including the step of determining physical relationships between each of the operating devices.

5. The method of claim 1 wherein the expected value varies over a predetermined time.

6. The method of claim 1 wherein the step of determining the cost associated with a deviation includes the step of determining the duration of the deviation.

7. The method of claim 1 wherein the step of determining the cost associated with a deviation includes the step of applying a weighing value to each deviation.

8. The method of claim 7 wherein the weighing value is based on an equipment type, climate zone or deviation history.

9. The method of claim 1 wherein the step of determining the cost associated with a deviation includes the step of determining the operational effect of the deviation on related devices based on the operational relationships between devices.

10. A equipment testing system including a memory, a processor, and an information gathering unit with a program in the processor performing the steps of:
identifying a device associated with an operational deviation;
establishing a communication connection with a device controlling the operation of the device;
retrieving a test routine that includes a plurality of commands each with an expected reaction by the device, the test routine being based on a category of the device and a category of the deviation;
sending a first command to the device;
receiving a response from the device;
determining if the response corresponds to the expected reaction by the device;
sending a second command based on the reaction to the first command.

11. The method of claim 10 wherein more than one command is associated with an expected reaction of the device.

12. The method of claim 10 wherein the expected reaction is measured by a sensor connected to the device.

13. The method of claim 10 including the step of generating a report detailing the results of the test.

14. The method of claim 10 including the step of determining the cause of an unexpected result.

15. The method of claim 14 including the step of generating a work order to correct the cause of the unexpected result.

16. The method of claim 15 including the step of initiating second test based on the work order.

17. The method of claim 10 wherein the communication connection is a BACnet connection.

18. The method of claim 10 wherein the communication connection is a LonWorks connection.

19. The method of claim 10 wherein the communication connection is a Modbus connection.

20. The method of claim 10 wherein the communication connection includes a plurality of communication connections.
